(19) United States
(12) Patent Application Publication
(10) Pub. No.: US 2026/0225272 A1
(43) Pub. Date: Aug. 6, 2026

(54) RAZOR CARTRIDGE

(71) Applicant: DORCO CO., LTD., Seoul (KR)

(72) Inventor: Min Joo PARK, Seoul (KR)

(21) Appl. No.: 19/630,927

(22) Filed: Mar. 27, 2026

Related U.S. Application Data
(63) Continuation of application No. PCT/KR2024/007652, filed on Jun. 4, 2024.

(30) Foreign Application Priority Data
Nov. 30, 2023 (KR) 10-2023-0170838

(51) Int. Cl. B26B 21/22; B26B 21/12

(52) U.S. Cl. CPC B26B 21/222; B26B 21/12

(57) ABSTRACT

A razor cartridge may include at least one blade formed with a cutting edge. The razor cartridge may also include a blade housing including a blade window in which the at least one blade is seated in a longitudinal direction and the cutting edge is at least partially exposed. The razor cartridge may further include an erector located in front of the cutting edge of the at least one blade, protruding to extend along the longitudinal direction on an upper surface of the blade housing, and forming a hair erecting area to erect hair between the cutting edge and the erector.

### CROSS-REFERENCE TO RELATED APPLICATIONS

This is a continuation application of International Patent Application No. PCT/KR 2024/007652 filed on Jun. 4, 2024, which claims the benefit of Korean Patent Application No. 10-2023-0170838 filed on Nov. 30, 2023, contents of each of which are incorporated herein by reference in their entireties.

### BACKGROUND

### Technical Field

The disclosure relates to a razor cartridge, and more particularly to a razor cartridge in which a blade is accommodated.

### Description of Related Technology

A razor refers to a device that is used to cut body hair such as fine hair and beard from a face or body. The razor includes a handle for gripping, and a razor cartridge for shaving while being in contact with skin.

The razor is classified into a system razor having a replaceable razor cartridge, and a portable razor having a nonreplaceable razor cartridge.

### SUMMARY

One aspect is a razor cartridge in which skin is prevented from getting a cut and tugging is reduced, thereby exhibiting an improved shave feeling.

Another aspect is a razor cartridge in which foreign substances such as lubricating substances applied to skin and body hair are more effectively removed, thereby enabling a clean shave.

Another aspect is a razor cartridge which can reduce tugging and remove foreign substances without increasing the size of the razor cartridge compared to conventional one.

The aspects of the disclosure are not limited to those described herein, and other aspects not mentioned herein may become apparent to those skilled in the art from the following description.

Another aspect is a razor cartridge that includes: at least one blade formed with a cutting edge; a blade housing including a blade window in which the at least one blade is seated in a longitudinal direction and the cutting edge is at least partially exposed; and an erector located in front of the cutting edge of the at least one blade, protruding to extend along the longitudinal direction on an upper surface of the blade housing, and forming a hair erecting area to erect hair between the cutting edge and the erector.

Another aspect is a razor cartridge that includes: at least one blade formed with a cutting edge; and a blade housing including a blade window in which the at least one blade is seated in a longitudinal direction and the cutting edge is at least partially exposed, wherein the blade housing includes a hair erecting area formed to erect hair, and a wiping area formed to wipe away at least some of foreign substances from at least one of skin and hair, the hair erecting area and the wiping area are formed within a transverse width of 0.4 mm to 5 mm in front of the cutting edge of the at least one blade.

Other details of the disclosure are included in the detailed description and the accompanying drawings.

According to the embodiments of the disclosure, the effects are at least as follows.

The razor cartridge according to an embodiment of the disclosure prevents skin from getting a cut and reduces tugging, thereby improving a shave feeling.

Further, foreign substances, such as lubricating substances, applied to skin and hair are more effectively removed, thereby enabling a clean shave.

In addition, there are no needs for increasing the area of the razor cartridge compared to conventional one to reduce the tugging and remove the foreign substances.

The effects of the disclosure are not limited to those described above, and various other effects are included in the foregoing description.

### BRIEF DESCRIPTION OF THE DRAWINGS

FIG. 1 is a plan view schematically showing a razor cartridge according to a first embodiment of the disclosure.

FIG. 2 is a partially enlarged perspective view of an erector according to the first embodiment of the disclosure.

FIG. 3 is a partially enlarged plan view of the erector according to the first embodiment of the disclosure.

FIG. 4 is a cross-sectional view of the erector taken along line A-A in FIG. 2.

FIG. 5 is a perspective view schematically showing a guard bar and a blade which are included in a conventional razor cartridge.

FIGS. 6 and 7 are views for explaining a tugging phenomenon caused by the conventional razor cartridge shown in FIG. 5.

FIG. 8 is a perspective view schematically showing a guard comb and a blade which are included in a conventional razor cartridge.

FIGS. 9 to 11 are views for explaining a shaving effect of the erector according to the first embodiment of the disclosure.

FIG. 12 is an enlarged view showing an example that a discharging hole is formed within a wiping area of the erector.

FIG. 13 is a partially enlarged plan view of an erector according to a second embodiment of the disclosure.

FIG. 14 is a partially enlarged plan view of an erector according to a third embodiment of the disclosure.

FIG. 15 is a partially enlarged plan view of an erector according to a fourth embodiment of the disclosure.

FIG. 16 is a partially enlarged plan view of an erector according to a fifth embodiment of the disclosure.

FIG. 17 is a partially enlarged plan view of an erector according to a sixth embodiment of the disclosure.

FIG. 18 is a partially enlarged plan view of an erector according to a seventh embodiment of the disclosure.

### DETAILED DESCRIPTION

In the razor cartridge, at least one blade is longitudinally accommodated in the blade housing, and the cutting edge of the blade is exposed through the top of the blade housing.

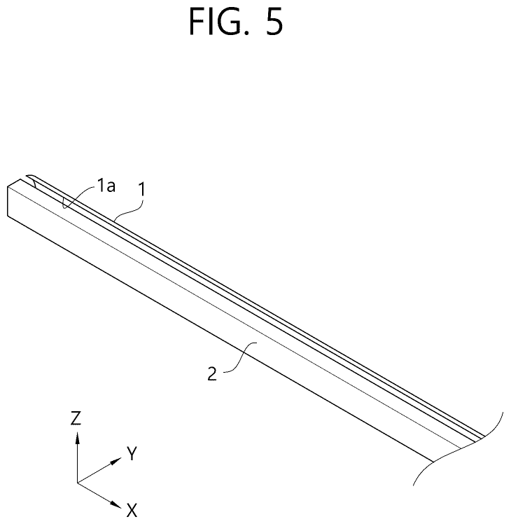

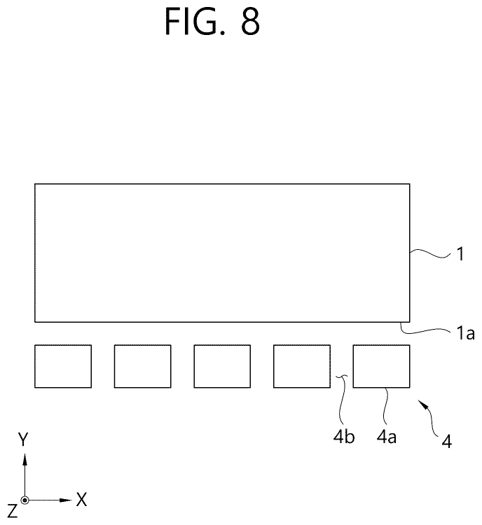

To avoid getting a cut on skin from the blade or to make body hair align, some razor cartridges may include a guard bar (see FIG. 5) or a guard comb (see FIG. 8) in front of a cutting edge.

However, the guard bar prevents skin from getting a cut, but often impairs a shave feeling because it makes body hair to be cut lie on skin and causes a tugging phenomenon that the body hair is tugged during a shaving process.

In addition, the guard comb aligns body hair with spaces between the teeth of the comb, but reduces shaving performance because a lubricating substance such as shaving cream passes through the spaces between the teeth of the comb along with the body hair.

Further, the razor cartridge is also used to cut body hair from a face. In this case, the razor cartridge needs to effectively cut the body hair in narrow places, for example, under a chin or nose, around an ear, etc., and there are limitations in that it is difficult to increase the surface area of the cartridge beyond a certain extent.

Accordingly, there is a limit on adding various functional parts for improving shaving effects to the razor cartridge.

The merits and characteristics of the disclosure and a method for achieving the merits and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments in this specification will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Further, first, second, i), ii), a), b) and the like terms may be used in describing elements according to embodiments of the disclosure. Such terms are used solely for the purpose of differentiating one element from another, but not limit the substances, the order, sequence, etc. of those elements. Throughout this specification, when a part ‘includes’ or ‘comprises’ an element, the part is meant to further include other elements rather than excluding other elements unless otherwise stated explicitly.

Below, a razor cartridge according to embodiment of the disclosure will be described with reference to the accompanying drawings.

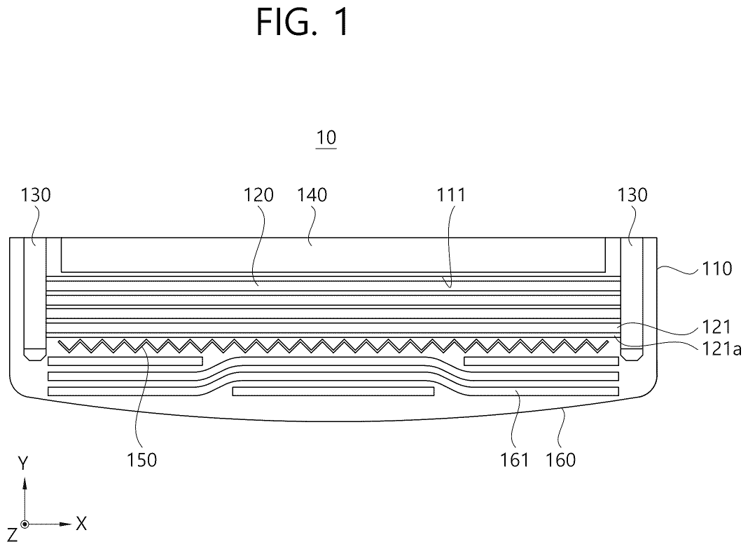

FIG. 1 is a plan view schematically showing a razor cartridge 10 according to a first embodiment of the disclosure.

Referring to FIG. 1, the razor cartridge 10 according to the first embodiment of the disclosure may include a blade housing 110 and at least one blade 120. FIG. 1 illustrates the razor cartridge 10 including four blades 120, but the number of blades 120 may be varied.

The blade housing 110 includes a blade window 111 formed penetrating the central portion thereof vertically (i.e., in a Z direction). The blade window 111 may have a rectangular shape which is long in a longitudinal direction (i.e., in an X direction).

The blade 120 is accommodated in the blade housing 110 in the longitudinal direction so as to cross the blade window 111.

The blade 120 includes a cutting edge 121a formed at the top thereof (i.e., the end of a positive Z direction), and the cutting edge 121a is at least partially exposed above the razor cartridge 10 (in the positive Z direction) through the blade window 111. The blade 120 may be installed so that the cutting edge 121a can face the front of the razor cartridge 10 (in a negative Y direction).

Referring to FIG. 1, the razor cartridge 10 may further include a clip 130. The clip 130 may hold the blade 120 in the blade housing 110. The clip 130 prevents the blade 120 from being separated from the blade housing 110.

Referring to FIG. 1, the razor cartridge 10 may further include a lubricating band 140. The lubricating band 140 is located at the rear of the blade window 111 (in a positive Y direction), and exposed to the upper surface of the blade housing 110 (in the positive Z direction). The lubricating band 140 contains a lubricating substance on the surface thereof, and applies the lubricating substance while being in contact with the surface of skin on which the blade 120 has passed during a shaving process. The lubricating substance may contain ingredients for protecting the skin after the shaving and provide softness to a user during the shaving to enable a soft stroke.

Referring to FIG. 1, the razor cartridge 10 may further include a guard 160. The guard 160 may be provided in front of the blade window 111 (in the negative Y direction), and form a front portion of the blade housing 110. The guard 160 comes into contact with a user's skin during a shaving process and pulls the skin, thereby preventing the skin from being cut by the blade 120. To more effectively pull the user's skin, the guard 160 may have an embossed or engraved pattern on the upper surface thereof, and the upper surface of the guard 160 may be made of rubber, silicone, or the like material.

Referring to FIG. 1, the razor cartridge 10 may further include an erector 150.

The erector 150 may be located in front (in the negative Y direction) of the cutting edge 121a of a frontmost blade 121 among the blades 120. The erector 150 may be provided between the cutting edge 121a of the frontmost blade 121 and the guard 160, and the erector 150 may be adjacent to the cutting edge 121a of the frontmost blade 121. According to an alternative embodiment, the erector 150 may be provided between the plurality of blades 120, or may be provided in front of each of the blades 120. Below, for convenience of description, description will be made based on an example that the erector 150 is located in front of the frontmost blade 120.

The erector 150 may protrude from the upper surface of the blade housing 110, and extend along the longitudinal direction (in the X direction). As shown in FIG. 1, the erector 150 may extend from one longitudinal side to the other longitudinal side in front of the blade window 111. Alternatively, the erector 150 may extend to be longer than the longitudinal length of the blade window 111 on both sides in the longitudinal direction. The erector 150 may extend continuously along the longitudinal direction.

Below, the erector 150 will be described in more detail.

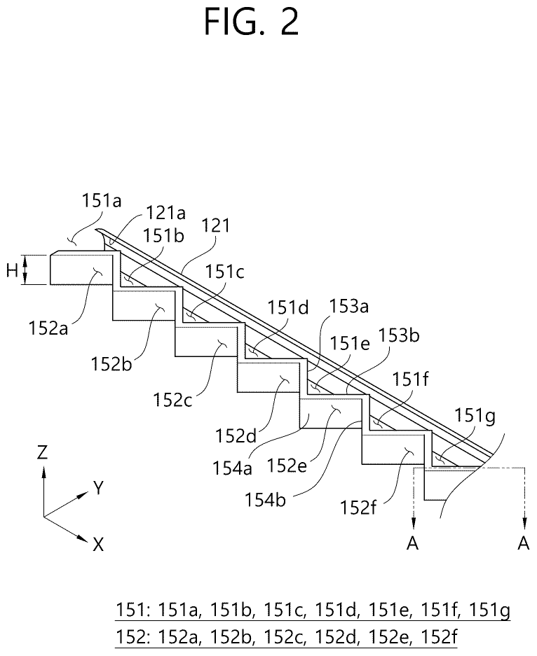

FIG. 2 is a partially enlarged perspective view of the erector 150 according to the first embodiment of the disclosure.

Referring to FIG. 2, the erector 150 according to the first embodiment of the disclosure is provided forming a hair erecting area 151 including a plurality of individual hair erecting areas 151a, 151b, 151c, 151d, 151e, 151f, and 151g, and a wiping area 152 including a plurality of individual wiping areas 152a, 152b, 152c, 152d, 152e, and 152f.

The hair erecting area 151 refers to a space formed behind the erector 150 (in the positive Y direction). In other words, the hair erecting area 151 is formed between the erector 150 and the cutting edge 121a of the frontmost blade 121. The hair erecting area 151 may provide a space enough for hair to be erected on skin before entering the frontmost blade 121, thereby reducing tugging and improving shaving performance.

The wiping area 152 refers to a space formed in front of the erector 150 (in the negative Y direction). In other words, the wiping area 152 is formed between the erector 150 and the guard 160. The wiping area 152 may remove or reduce foreign substances remaining on hair and/or skin before the hair enters the frontmost blade 121, thereby improving a shave feeling.

The erector 150 serves as a partition between the wiping area 152 and the hair erecting area 151, thereby forming the wiping area 152 and the hair erecting area 151 at a time. Accordingly, both the wiping function and the hair erecting function are implemented by a single member within a limited area of the razor cartridge, thereby advantage that the razor cartridge 10 can be compactly designed.

The hair erecting area 151 may be located directly after the wiping area 152, so that hair can be erected through the hair erecting area 151 immediately after foreign substances are removed through the wiping area 152. Meanwhile, the frontmost blade 121 is directly adjacent to the hair erecting area 151, and thus additional foreign substances can be hardly introduced until hair reaches the frontmost blade 121 after passing through the hair erecting area 151. Accordingly, hair from which foreign substances have been sufficiently removed reaches the frontmost blade 121, thereby further improving the shaving performance.

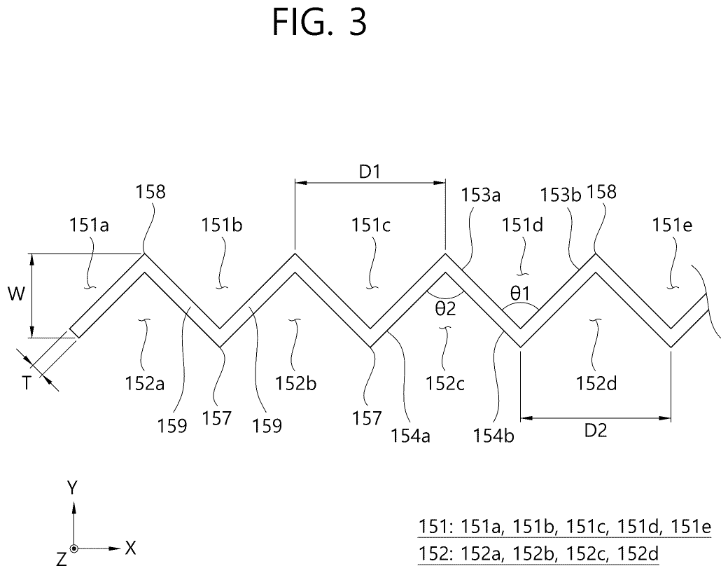

Further, an empty space enough for hair erected by the hair erecting area 151 to remain erect until reaching the cutting edge 121a of the frontmost blade 121 may be formed between the hair erecting area 151 and the cutting edge 121a of the frontmost blade 121. The empty space may refer to a space between the rearmost point (i.e., the rearmost end of a rear protruding end 158 (see FIG. 3) of the erector 150 and the cutting edge 121a of the frontmost blade 121. Alternatively, the empty space may refer to a space between the hair erecting area 151 and the cutting edge 121a of the frontmost blade 121. The hair erected within the hair erecting area 151 reaches the cutting edge 121a of the frontmost blade 121 while remaining erect in the empty space, thereby reducing the tugging during shaving.

The rear surfaces 153a and 153b of the erector 150 form the hair erecting area 151. In more detail, the rear surfaces 153a and 153b of the erector 150 are formed in such a manner that a first rear surface 153a and the second rear surface 153b are alternately extended in the longitudinal direction (in the X direction). The second rear surface 153b extends from the first rear surface 153a and faces the first rear surface 153a. Spaces where the first rear surface 153a and the second rear surface 153b face each other form individual hair erecting areas 151a, 151b, 151c, 151d, 151e, 151f, and 151g, respectively. In other words, the first rear surface 153a is located on one longitudinal side (in a negative X direction) of each of the individual hair erecting areas 151a, 151b, 151c, 151d, 151e, 151f, and 151g, and the second rear surface 153b is located on the other longitudinal side (in a positive X direction) of each of the individual hair erecting areas 151a, 151b, 151c, 151d, 151e, 151f, and 151g. Referring to FIG. 2, the first rear surface 153a and the second rear surface 153b may be formed so that at least some of the individual hair erecting areas 151a, 151b, 151c, 151d, 151e, 151f, and 151g can have widths that gradually widen rearwards.

The front surfaces 154a and 154b of the erector 150 form the wiping area 152. In more detail, the front surfaces 154a and 154b of the erector 150 are formed in such a manner that a first front surface 154a and a second front surface 154b are alternately extended in the longitudinal direction (in the X direction). The second front surface 154b extends from the first front surface 154a and faces the first front surface 154a, so that spaces where the first front surface 154a and the second front surface 154b face each other can form individual wiping areas 152a, 152b, 152c, 152d, 152e, and 152f, respectively. In other words, the first front surface 154a is located on one longitudinal side (in the negative X direction) of each of the individual wiping areas 152a, 152b, 152c, 152d, 152e, and 152f, and the second front surface 154b is located on the other longitudinal side (in the positive X direction) of each of the individual wiping areas 152a, 152b, 152c, 152d, 152e, and 152f. Referring to FIG. 2, the first front surface 154a and the second front surface 154b may be formed so that at least some of the individual wiping areas 152a, 152b, 152c, 152d, 152e, and 152f can have widths that gradually narrow rearwards.

The first front surface 154a may be located on the opposite side of the second rear surface 153b, and the second front surface 154b may be located on the opposite side of the first rear surface 153a.

The individual hair erecting areas 151a, 151b, 151c, 151d, 151e, 151f, and 151g may be located behind the individual wiping areas 152a, 152b, 152c, 152d, 152e, and 152f (in the positive Y direction), but the individual hair erecting areas 151a, 151b, 151c, 151d, 151e, 151f, and 151g and the individual wiping areas 152a, 152b, 152c, 152d, 152e, and 152f may be alternately located in a transverse direction. In other words, one of the individual wiping areas 152a, 152b, 152c, 152d, 152e, and 152f may be located between two adjacent individual hair erecting areas 151a, 151b, 151c, 151d, 151e, 151f, and 151g.

The erector 150 may be appropriately designed to have a protruding height H in consideration of the amount of foreign substance desired to be removed through the wiping area 152 and/or the length of hair desired to be elected through the hair erecting area 151. For example, the protruding height H of the erector 150 may be designed within a range of 0.4 mm to 10 mm.

FIG. 3 is a partially enlarged plan view of the erector 150 according to the first embodiment of the disclosure.

Referring to FIG. 3, the transverse width W of the erector 150 may be designed in a range of 0.4 mm to 5 mm. The transverse width W of the erector 150 may be a straight line distance in the transverse direction (in the Y direction) between the frontmost point and the rearmost point of the erector 150. The frontmost point of the erector 150 may be a boundary between the first front surface 154a and the second front surface 154b. The rearmost point of the erector 150 may be a boundary between the first rear surface 153a and the second rear surface 153b.

According to an embodiment of the disclosure, the razor cartridge 10 may have both the wiping area 152 where foreign substances are wiped from skin and/or hair and the hair erecting area 151 where the hair is erected, within the limited area having the transverse width W of 0.4 mm to 5 mm. Accordingly, the razor cartridge 10 according to an embodiment of the disclosure may provide a safer and improved shave feeling, and provide both the hair erecting function and the foreign substance removing function to optimize a shaving efficiency, without significant expansion of the width in the transverse direction.

Referring to FIG. 3, the thickness T of the erector 150 may be designed in a range of 0.2 mm to 1 mm. The thickness T of the erector 150 may refer to a distance between the front surfaces 154a and 154b and the rear surfaces 153a and 153b. Alternatively, the thickness T may be distances between individual hair erecting areas 151a, 151b, 151c, 151d, and 151e and individual wiping areas 152a, 152b, 152c, and 152d, which are adjacent to each other. Alternatively, the thickness T of the erector 150 may be a distance between the first front surface 154a and the second rear surface 153b which are adjacent to each other and/or a distance between the second front surface 154b and the first rear surface 153a which are adjacent to each other. The thickness T of the erector 150 may be designed to be uniform. However, the disclosure is not limited to this embodiment, and the thickness T of the erector 150 may be not uniform.

Referring to FIG. 3, each width D1 of the individual hair erecting areas 151a, 151b, 151c, 151d, and 151e in the longitudinal direction (in the X direction) may be designed in a range of 0.2 mm to 2.5 mm. Each width D1 of the width individual hair erecting areas 151a, 151b, 151c, 151d, and 151e in the longitudinal direction may be the maximum distance between the first rear surface 153a and the second rear surface 153b facing or adjacent to the first rear surface 153a. The individual hair erecting areas 151a, 151b, 151c, 151d, and 151e may have the same or different widths D1 in the longitudinal direction.

Referring to FIG. 3, each width D2 of the individual wiping areas 152a, 152b, 152c, and 152d in the longitudinal direction (in the X direction) may be designed in a range of 0.2 mm to 2.5 mm. Each width D2 of the wiping areas 152a, 152b, 152c, and 152d in the longitudinal direction may be the maximum distance between the first front surface 154a and the second front surface 154b facing or adjacent to the first front surface 154a. The individual wiping areas 152a, 152b, 152c, and 152d may have the same or different widths D2 in the longitudinal direction.

Each width of the individual hair erecting areas 151a, 151b, 151c, 151d, and 151e in the longitudinal direction and each width of the individual wiping areas 152a, 152b, 152c, and 152d in the longitudinal direction may be equal to or different from each other.

Referring to FIG. 3, an angle θ1 formed at a boundary point between the first rear surface 153a and the second rear surface 153b may be smaller than 180 degrees. In more detail, the angle θ1 may be designed in a range of 8 degrees to 136 degrees. The angles θ1 of the individual hair erecting areas 151a, 151b, 151c, 151d, and 151e may be equal to or different from each other.

Referring to FIG. 3, an angle θ2 formed at a boundary point between the first front surface 154a and the second front surface 154b may be smaller than 180 degrees. In more detail, the angle θ2 may be designed in a range of 8 degrees to 136 degrees. The angles θ2 of the individual wiping areas 152a, 152b, 152c, and 152d may be equal to or different from each other.

Referring to FIG. 3, the erector 150 may be defined with a plurality of front protruding ends 157 arranged being spaced apart along the longitudinal direction (in the X direction), a plurality of rear protruding ends 158 arranged being spaced apart along the longitudinal direction and located the blade 120 (see FIG. 2) and between the plurality of front protruding ends 157, and protruding end connecting portions 159 continuously connecting the plurality of front protruding ends 157 and the plurality of rear protruding ends 158.

The individual hair erecting areas 151a, 151b, 151c, 151d, and 151e are formed in the spaces between the adjacent rear protruding ends 158, and the individual wiping areas 152a, 152b, 152c, and 152d are formed in the spaces between the adjacent front protruding ends 157.

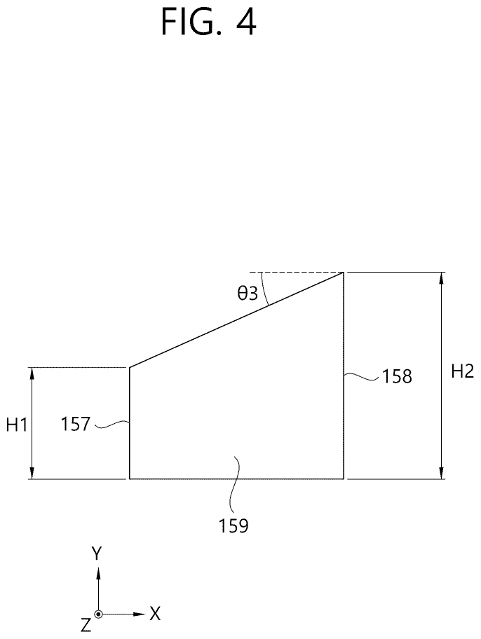

FIG. 4 is a cross-sectional view of the erector 150 taken along line A-A in FIG. 2.

Referring to FIG. 4, the erector 150 may be formed in such a manner that the height H1 of the front protruding end 157 is lower than the height H2 of the rear protruding ends 158. In other words, the upper surface of the erector 150 may have a downward slope facing forward (in the negative Y direction). Thus, when the razor cartridge 10 moves forward (in the negative Y direction) along the surface of the skin upon a shaving stroke, the skin and hair may be naturally pressed against the erector 150 while moving from the front protruding end 157 toward the rear protruding ends 158 along the upper surface of the erector 150.

An angle θ3 between the upper surface of the erector 150 and a horizontal plane (an X-Y plane) may be greater than or equal to 0 degrees, or may be smaller than or equal to 60 degrees. When θ3 is smaller than 60 degrees, a user who strokes the razor can have a soft shave without irritating his/her skin.

Meanwhile, FIG. 4 shows an embodiment that the height H1 of the front protruding end 157 is lower than the height H2 of the rear protruding ends 158, but the disclosure is not limited to this embodiment. Accordingly, according to an alternative embodiment of the disclosure, the height H1 of the front protruding end 157 may be higher than the height H2 of the rear protruding ends 158, or the two heights H1 and H2 may be equal to each other.

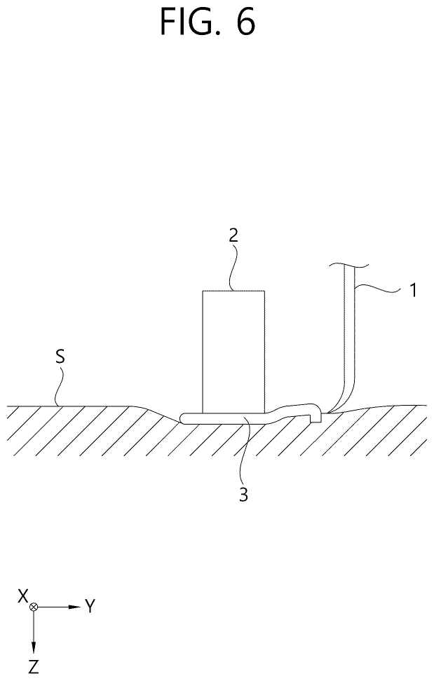

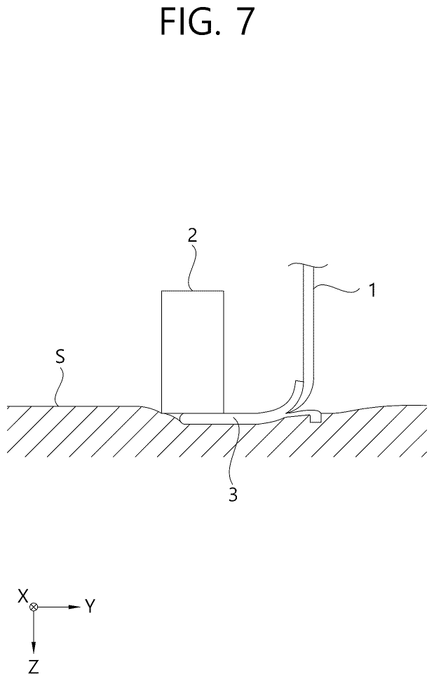

FIG. 5 is a perspective view schematically showing a guard bar and a blade which are included in a conventional razor cartridge, and FIGS. 6 and 7 are views for explaining a tugging phenomenon caused by the conventional razor cartridge shown in FIG. 5.

Referring to FIG. 5, some conventional razor cartridges include a guard bar 2 protruding in front of a cutting edge 1a of the frontmost blade 1 among a plurality of blades. Here, the upper surface of the guard bar 2 may be a generally even surface without having uneven portions.

The guard bar 2 is adjacent to the cutting edge 1a, and supports skin in front of the cutting edge 1a during a shaving process, thereby preventing the skin from being cut by the cutting edge 1a.

Referring to FIG. 6, the guard bar 2 and the blade 1 move forward (in the negative Y direction) along skin S during a shaving process. The hair 3 is pressed against the guard bar 2 immediately before the blade 1, and thus lies down toward the skin S.

To prevent he skin S from rising in a space between the guard bar 2 and the blade 1 and being cut by the blade 1, a distance between the guard bar 2 and the frontmost blade 1 is very short. Accordingly, as shown in FIG. 7, the hair 3 is cut by the blade 1 while lying down toward the skin S through the guard bar 2, and thus the hair 3 is often cut not cleanly but long in an oblique direction of the hair 3. In this case, a phenomenon of tugging the hair 3 occurs, thereby impairing a shave feeling and causing an unclean shave.

FIG. 8 is a perspective view schematically showing a guard comb and a blade which are included in a conventional razor cartridge.

Referring to FIG. 8, some conventional razor cartridges include a guard comb 4 protruding toward the front (in the negative Y direction) of the cutting edge 1a of the frontmost blade 1 among the plurality of blades.

The guard comb 4 includes a plurality of comb members 4a formed protruding along the longitudinal direction (in the X direction). Between the adjacent comb members 4a are formed comb gaps 4b.

Like the foregoing guard bar 2, the comb members 4a support skin in front of the cutting edge 1a during a shaving process, thereby preventing the skin from being cut by the cutting edge 1a. The comb gaps 4b align the hair entering therein along a shaving direction.

The hair entering the comb gaps 4b is cut by the blade 1 while being erected on the skin, thereby minimizing a tugging phenomenon. However, foreign substances, such as shaving cream or soap foam, which have been applied by a user to the skin to have a shave, may also enter the comb gaps 4b along with the hair. When the shaving cream or the like that enters the comb gaps 4b more than necessary acts as an obstacle to having a shave. For example, the shaving cream, soap foam or the like foreign substances remaining in the hair may be an obstacle to having an appropriate shave by making the blade 1 slip on the hair. Further, if the comb gaps 4b are clogged with the foreign substances collected in the comb gaps 4b during the shaving process, the hair is not aligned and erected through the comb gaps 4b, thereby decreasing a shaving effect toward the end of the shaving.

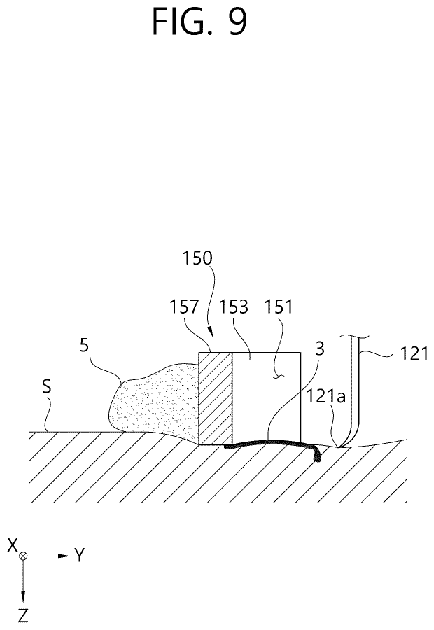

FIGS. 9, 10, and 11 are views for explaining a shaving effect of the erector 150 according to the first embodiment of the disclosure.

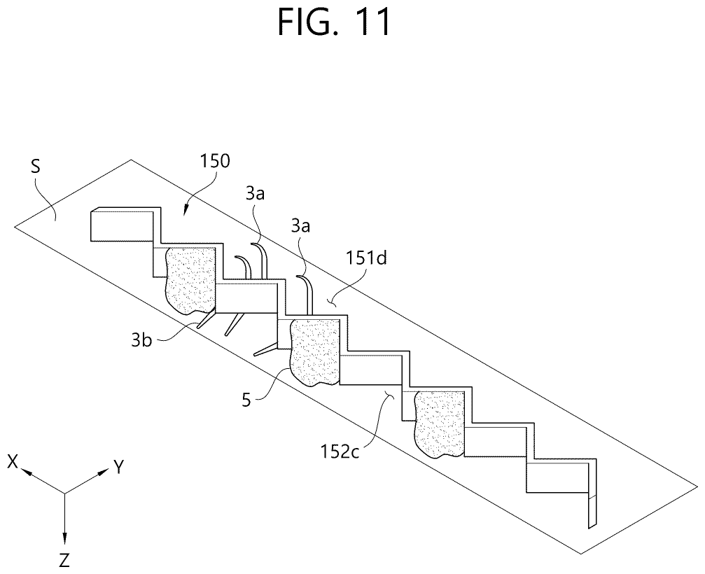

Referring to FIG. 9, the erector 150 and the frontmost blade 121 also move forward (in the negative Y direction) along skin S during a shaving process. Referring to FIGS. 9 and 11, hair 3 or 3b lies toward the skin S by the front protruding end 157 of the erector 150.

However, the rear protruding end 158 of the erector 150 is adjacent to the cutting edge 121a and supports the skin S immediately before the cutting edge 121a of the frontmost blade 121. Accordingly, a gap between the front protruding end 157 and the cutting edge 121a of the frontmost blade 121 may be formed larger than the gap between the foregoing guard bar 2/comb members 4a and the cutting edge 1a.

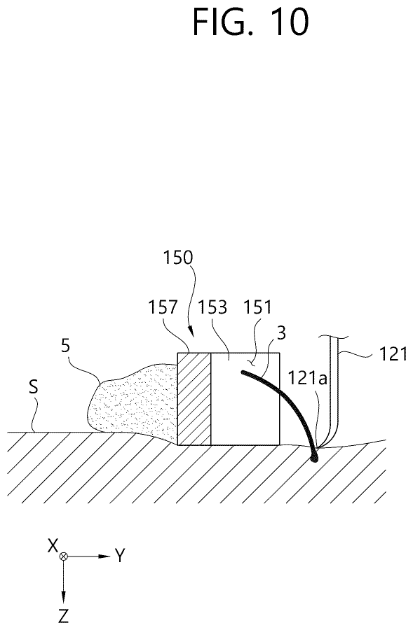

When the erector 150 moves in the state shown in FIG. 9, so that the end of the hair 3 can passes through the rear surface 153, the hair 3 or 3a is erected in the hair erecting area 151 as shown in FIGS. 10 and 11. Even in the state shown in FIG. 10, the erector 150 supports the skin S around the hair 3, thereby preventing the skin S from rising in the space between the front protruding end 157 and the cutting edge 121a, i.e., the hair erecting area 151.

Accordingly, the skin S around the hair 3 is prevented from being cut by the cutting edge 121a, and the hair 3 is cut by the cutting edge 121a while being erected, thereby having a safe and clean shave, and reducing the tugging phenomenon to improve a shave feeling.

Further, referring to FIGS. 9 to 11, the front surfaces 154a and 154b of the erector 150 wipe foreign substances 5 from the skin S and/or the hair 3 in front of the erector 150 while the erector 150 moves forward (in the negative Y direction) during the shaving process. The foreign substances 5 may include shaving cream, soap foam, wastes, etc. The foreign substances 5 wiped by the front surfaces 154a and 154b of the erector 150 may be collected in the wiping area 152. Referring to FIG. 10, the erector 150 may wipe away surplus foreign substances 5 such as shaving cream or soap foam, remove overall foreign substances 5, or passes only foreign substances 5 as much as required to exhibit shaving performance.

Accordingly, the razor cartridge including the erector 150 can provide a good feeling of shaving that is clean and decreased in the tugging compared to the foregoing conventional razor cartridge.

The guard comb 4 (see FIG. 8) described with reference to FIG. 8 requires the plurality of comb members 4a (see FIG. 8) to implement the hair erecting function. On the other hand, the erector 150 according to the first embodiment of the disclosure forms the plurality of individual hair erecting areas 151a, 151b, 151c, 151d, 151e, 151f, and 151g as a single body, thereby having advantages of having a simple structure and being easy to manufacture compared to the guard comb 4.

Further, the comb gaps 4b of the guard comb 4 are penetrated forward and backward, thereby having structural limitations in simultaneously performing both the erection of hair and the removal of foreign substances. On the other hand, the erector 150 according to the first embodiment of the disclosure is continuously formed without any penetrated portion, thereby having advantages of simultaneously performing both the erection of hair and the removal of foreign substances.

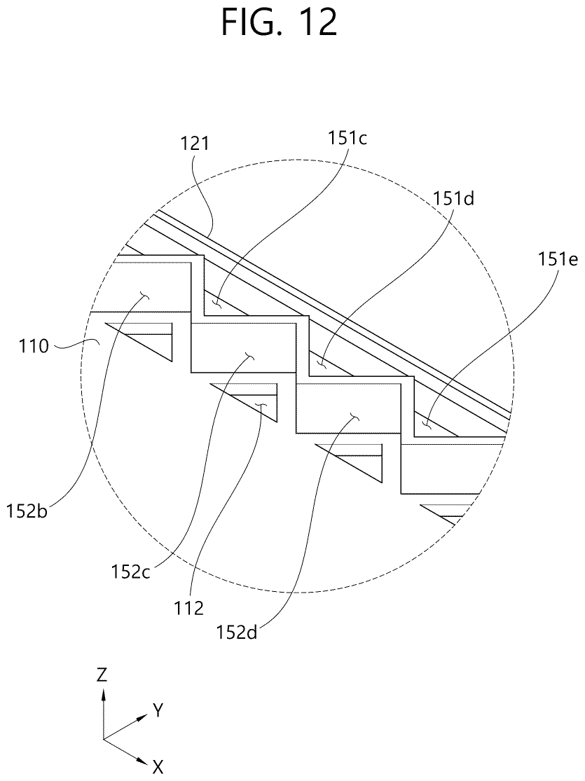

FIG. 12 is an enlarged view showing an example that a discharging hole 112 is formed within a wiping area 152 of the erector 150.

Referring to FIG. 12, the razor cartridge according to an embodiment of the disclosure may include at least one discharging hole 112 formed by penetrating the blade housing 110 up and down (in the Z direction). The discharging hole 112 may be formed between the erector 150 and the guard 160 (see FIG. 1), for example, between the erector 150 and the guard pattern 161 (see FIG. 1). The discharging hole 112 may be formed in at least some among the individual wiping areas 152b, 152c, and 152d.

The discharging hole 112 may guide foreign substances 5, which have been introduced into the individual wiping areas 152b, 152c, and 152d, to be discharged through a lower portion of the blade housing 110 (in the negative Z direction).

Below, the electors according to alternative embodiments will be described.

For convenience of description, elements similar to those of the first embodiment will be given the same reference numerals, and descriptions common to those for the first embodiment will be omitted.

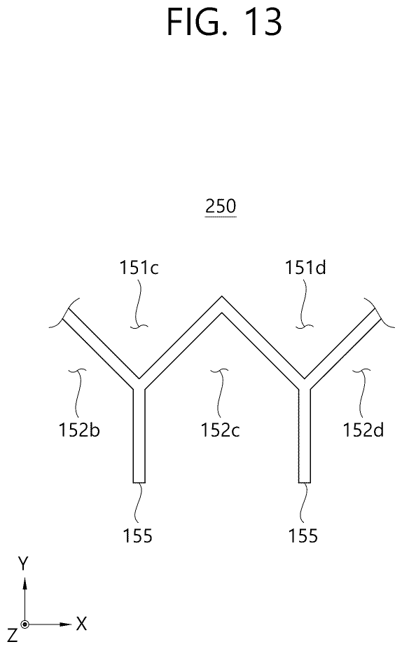

FIG. 13 is a partially enlarged plan view of an erector 250 according to a second embodiment of the disclosure.

Referring to FIG. 13, the erector 250 according to the second embodiment may further include a wiping guide 155 compared to the foregoing erector 150 according to the first embodiment.

The wiping guide 155 may be formed to have a structure for guiding foreign substances 5 to be introduced into the individual wiping areas 152b, 152c, and 152d.

As shown in FIG. 13, the wiping guide 155 may be formed to divide the individual wiping areas 152b, 152c, and 152d. For example, the wiping guide 155 may extend from a boundary between the first front surface 154a and the second front surface 154b toward the front (in the negative Y direction). Alternatively, the wiping guide 155 may extend from the first front surface 154a and/or the second front surface 154b toward the front (in the negative Y direction).

The wiping guide 155 guides foreign substances on the front skin and/or hair to be introduced into each of the individual wiping areas 152b, 152c, and 152d. Further, the wiping guide 155 may expand the individual wiping areas 152b, 152c, and 152d to increase the amount of foreign substance collected in the individual wiping areas 152b, 152c, and 152d, thereby improving the performance of wiping the foreign substances.

Further, the wiping guide 155 is formed extending in parallel with a shaving direction so as to align hair in the shaving direction.

Further, the wiping guide 155 is formed extending in parallel with a shaving direction so as to guide the razor cartridge 10 to move along the shaving direction.

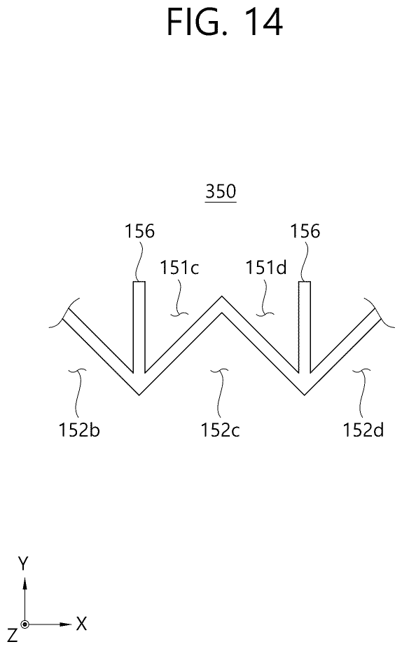

FIG. 14 is a partially enlarged plan view of an erector 350 according to a third embodiment of the disclosure.

Referring to FIG. 14, the erector 350 according to the third embodiment may further include a skin supporter 156 compared to the erector 150 according to the first embodiment.

The skin supporters 156 protrude within the individual hair erecting areas 151c and 151d, thereby supporting the skin not to rise within the individual hair erecting areas 151c and 151d. The skin supporter 156 may be formed in at least one of the individual hair erecting areas 151c and 151d.

As shown in FIG. 14, the skin supporter 156 may extend from the boundary between the first rear surface 153a and the second rear surface 153b toward the back (in the positive Y direction). Alternatively, the skin supporter 156 may extend from the first rear surface 153a and/or the second rear surface 153b toward the back (in the positive Y direction).

Further, the skin supporter 156 may extend close to the cutting edge 121a of the frontmost blade 121. The skin supporter 156 may extend to be in contact with or connected to the cutting edge 121a of the frontmost blade 121.

The skin supporter 156 supports skin more flatly and tightly to effectively prevent the skin from sagging. Thus, the skin is not scarred or cut.

Further, the skin supporter 156 may be formed extending in parallel with the shaving direction, thereby aligning hair in the shaving direction.

Further, the skin supporter 156 may be formed extending in parallel with the shaving direction, thereby guiding the razor cartridge 10 to move along the shaving direction.

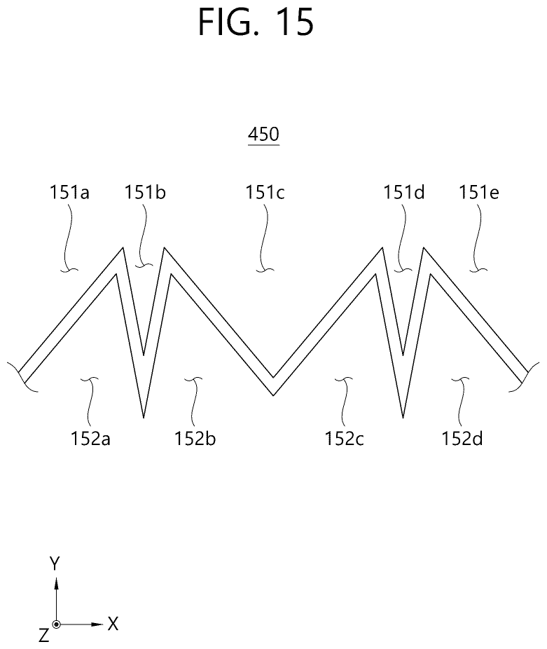

FIG. 15 is a partially enlarged plan view of an erector 450 according to a fourth embodiment of the disclosure.

The foregoing erector 150 according to the first embodiment has been described based on the example that the individual hair erecting areas 151a, 151b, 151c, 151d, 151e, 151f, and 151g and the individual wiping areas 152a, 152b, 152c, 152d, 152e, and 152f extend zigzagging along the longitudinal direction (in the X direction) to have approximately similar shapes and sizes to one another.

On the other hand, referring to FIG. 15, the erector 450 according to the fourth embodiment may include the individual hair erecting areas 151a, 151b, 151c, 151d, and 151e, at least some of which are different in shape and/or size from one another. For example, the first individual hair erecting area 151c is different in shape and/or size from the second individual hair erecting areas 151b and 151d.

Likewise, the erector may include the individual wiping areas 152a, 152b, 152c, and 152d, at least some of which are also different in shape and/or size from one another.

The individual hair erecting areas 151a, 151b, 151c, 151d, and 151e and/or individual wiping areas 152a, 152b, 152c, and 152d may be intentionally designed to be different in shape and/or size from one another to improve the shaving performance.

For example, during the shaving process, the skin may be supported by the clips 130 (see FIG. 1) located on both lateral sides of the blade housing 110 in the longitudinal direction (in the X direction), and thus have a central area slightly rising toward the blade 120. In this case, the longitudinal center area of the skin is more likely to be cut by the blade 120. To prevent the skin from getting such a cut, the individual hair erecting areas 151a, 151b, 151c, 151d, and 151e in the longitudinal center area may be designed to be smaller than the individual hair erecting areas 151a, 151b, 151c, 151d, and 151e in both the longitudinal lateral areas.

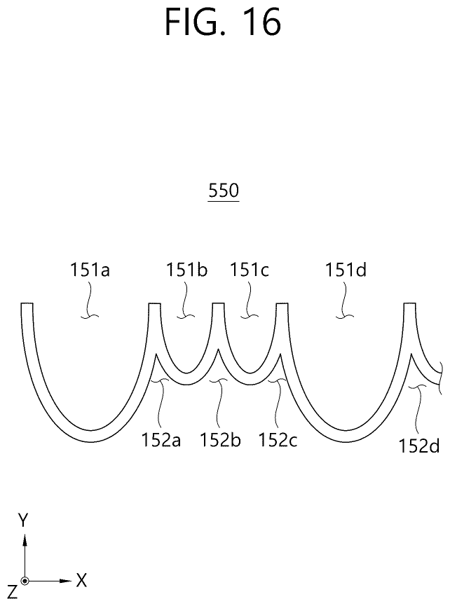

FIG. 16 is a partially enlarged plan view of an erector 550 according to a fifth embodiment of the disclosure.

The erectors 150, 250, 350, and 450 according to the first to fourth embodiments have been described based on the example that the individual hair erecting areas 151a, 151b, 151c, 151d, 151e, 151f, and 151g and the individual wiping areas 152a, 152b, 152c, 152d, 152e, and 152f are shaped like a polygon (for example, a triangle). In other words, the erectors 150, 250, 350, and 450 according to the first to fourth embodiments have been described based on the example that the front surface and the rear surface are flat.

On the other hand, referring to FIG. 16, the erector 550 according to the fifth embodiment may include the individual hair erecting areas 151a, 151b, 151c, and 151d and/or the individual wiping areas 152a, 152b, 152c, and 152d, at least some of which include curved surfaces. To this end, the erector 550 according to the fifth embodiment may include the first front surface, the second front surface, the boundary between the first front surface and the second front surface, the first rear surface, the second rear surface, and the boundary between the first rear surface and the second rear surface, at least some of which are curved.

For example, when each of the individual hair erecting areas 151a, 151b, 151c, and 151d has a U-shape, the individual hair erecting areas 151a, 151b, 151c, and 151d are relatively enlarged, thereby increasing the number of hairs to be erected therein. In this case, the hair erecting function is improved, thereby having an effect on minimizing the tugging phenomenon. On the other hand, when each of the individual wiping areas 152a, 152b, 152c, and 152d has a U-shape, the amount of foreign substance to be collected in the individual wiping areas 152a, 152b, 152c, and 152d may be increased, thereby maximizing wiping performance.

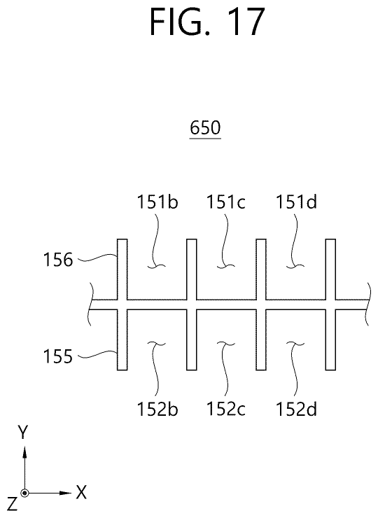

FIG. 17 is a partially enlarged plan view of an erector according to a sixth embodiment of the disclosure.

Referring to FIG. 17, the erector 650 according to the sixth embodiment may further include the wiping guide 155 and the skin supporter 156 compared to the foregoing erector 150 according to the first embodiment.

The wiping guide 155 is similar to that described with the foregoing erector 250 according to the second embodiment, and the skin supporter 156 is similar to that described with the foregoing erector 350 according to the third embodiment. Accordingly, the erector 650 according to the sixth embodiment has all the functions and effects described with the foregoing erector 250 according to the second embodiment and the foregoing erector 350 according to the third embodiment.

Referring to FIG. 17, the wiping guide 155 and the skin supporter 156 may be located on the same line along the transverse direction (in the Y direction). In this case, the individual hair erecting areas 151b, 151c, and 151d and individual wiping areas 152b, 152c, and 152d are arranged without being staggered in the transverse direction (Y direction). Such a structure uniformizes the removal of foreign substances from and the application of lubricating substances to the hairs erected within the individual hair erecting areas 151b, 151c, and 151d, thereby exhibiting uniform shaving performance.

However, according to an alternative embodiment, the wiping guide 155 and the skin supporter 156 may not be located on the same line along the transverse direction (in the Y direction).

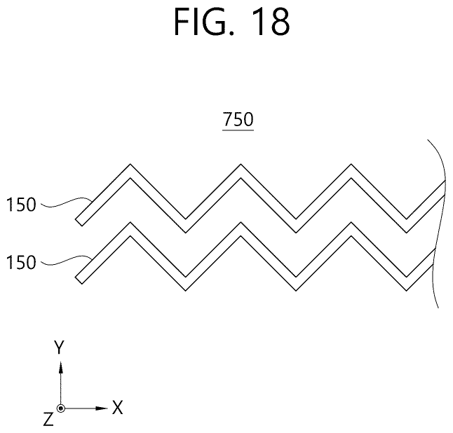

FIG. 18 is a partially enlarged plan view of an erector according to a seventh embodiment of the disclosure.

Referring to FIG. 18, the erector 750 according to the seventh embodiment may be configured in such a manner that two or more erectors 150 according to the first embodiment are arranged in the front and the rear. The erector located in the front and the erector located in the rear may be the same in material, protruding height, etc., but may also be different.

The erector 750 according to the seventh embodiment has the wiping areas overlapping in the transverse direction (in the Y direction), thereby improving the function of wiping away foreign substances.

FIG. 18 shows an example that the erectors 150 according to the first embodiment are arranged in the front and the rear. However, according to an alternative embodiment, at least some among the erectors 150, 250, 350, 450, 550, and 650 according to the first to sixth embodiments may be combined to overlap in the transverse direction (in the Y direction) and/or the longitudinal direction (in the X direction).

The foregoing embodiments have been described based on the example that the erector is structured as a single body extending continuously in the longitudinal direction (in the X direction). However, according to an alternative embodiment, the erector may be discretely provided in the longitudinal direction (in the X direction) and/or the transverse direction (in the Y direction). For example, the erector may include a plurality of unit erectors separated at regular or irregular intervals. The plurality of unit erectors may have uneven lengths in the longitudinal direction (in the X direction) and/or the transverse direction (in the Y direction).

A person having ordinary knowledge in the art to which the disclosure pertains can understood that the disclosure may be embodied in other specific forms without changing technical spirit or essential features. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor cartridge comprising:
at least one blade comprising a cutting edge;
a blade housing comprising a blade window in which the at least one blade is seated in a longitudinal direction and the cutting edge is at least partially exposed; and
an erector located in front of the cutting edge of the at least one blade, protruding to extend along the longitudinal direction on an upper surface of the blade housing, and forming a hair erecting area to erect hair between the cutting edge and the erector,
wherein the erector forms a wiping area located in front of the erector to wipe away at least some of foreign substances from at least one of skin and hair during a shaving process, and the hair erecting area located behind the erector,
wherein the erector comprises a rear surface forming the hair erecting area where hair of which an end has passed through the rear surface is erected during the shaving process,
wherein the rear surface is formed as a first rear surface and a second rear surface extending from the first rear surface to face the first rear surface, which are alternately formed, and
wherein the hair erecting area comprises individual hair erecting areas respectively formed in spaces between the first rear surface and the second rear surface.

2. The razor cartridge of claim 1, wherein:
the erector comprises a front surface that forms the wiping area, and
the front surface wipes away at least some of the foreign substances during the shaving process.

3. The razor cartridge of claim 2, wherein:
the front surface comprises a first front surface and a second front surface extending from the first front surface to face the first front surface, which are alternately formed, and
the wiping area comprises individual wiping areas respectively formed in spaces between the first front surfaces and the second front surfaces.

4. The razor cartridge of claim 3, wherein a maximum distance between the first front surface and the second front surface adjacent to the first front surface ranges from 0.2 mm to 2.5 mm.

5. The razor cartridge of claim 3, wherein the erector further comprises a wiping guide extending forward from at least one among the first front surface, the second front surface, and a boundary between the first front surface and the second front surface to guide the foreign substances to be introduced into the wiping area.

6. The razor cartridge of claim 1, wherein a maximum distance between the first rear surface and the second rear surface adjacent to the first rear surface ranges from 0.2 mm to 2.5 mm.

7. The razor cartridge of claim 1, wherein the erector further comprises a skin supporter formed protruding in the hair erecting area to support skin in the hair erecting area.

8. The razor cartridge of claim 7, wherein the skin supporter extends backward from at least one among the first rear surface, the second rear surface, and a boundary between the first rear surface and the second rear surface.

9. The razor cartridge of claim 1, wherein the erector has a thickness of 0.2 mm to 1 mm.

10. The razor cartridge of claim 1, wherein the blade housing comprises a discharging hole formed penetrating at least a portion of the wiping area up and down.

11. The razor cartridge of claim 1, wherein a transverse width in an area where the erector is located ranges from 0.4 mm to 5 mm.

12. The razor cartridge of claim 1, wherein the erector has a height of 0.4 mm to 10 mm.

13. The razor cartridge of claim 1, wherein an upper surface of the erector has a downward slope facing forward.

14. The razor cartridge of claim 1, further comprising a guard formed on the upper surface of the blade housing, and pulling skin while being in close contact with the skin during a shaving process,
wherein the erector is provided between the guard and the blade.

15. The razor cartridge of claim 1, wherein:
the wiping area is formed having a width that narrows rearwards, and
the hair erecting area is formed having a width that widens rearwards.

16. A razor cartridge comprising:
at least one blade formed with a cutting edge; and
a blade housing comprising a blade window in which the at least one blade is seated in a longitudinal direction and the cutting edge is at least partially exposed,
wherein the blade housing comprises a hair erecting area formed to erect hair, and a wiping area formed to wipe away at least some of foreign substances from at least one of skin and hair, the hair erecting area and the wiping area are formed within a transverse width of 0.4 mm to 5 mm in front of the cutting edge of the at least one blade,
wherein the erector forms a wiping area located in front of the erector, and the hair erecting area located behind the erector,
wherein the erector comprises a rear surface forming the hair erecting area where hair of which an end has passed through the rear surface is erected during the shaving process,
wherein the rear surface is formed as a first rear surface and a second rear surface extending from the first rear surface to face the first rear surface, which are alternately formed, and
wherein the hair erecting area comprises individual hair erecting areas respectively formed in spaces between the first rear surface and the second rear surface.
